(19) United States
(12) Patent Application Publication
(10) Pub. No.: US 2026/0014842 A1
(43) Pub. Date: Jan. 15, 2026

(54) COLLAPSIBLE HARD-SHELL TRUCK CAP

(71) Applicant: Jarred Wing, St. Joseph, MI (US)

(72) Inventor: Jarred Wing, St. Joseph, MI (US)

(21) Appl. No.: 18/770,054

(22) Filed: Jul. 11, 2024

(51) Int. Cl. B60J 7/16

(52) U.S. Cl. CPC B60J 7/1614

(57) ABSTRACT

A collapsible hard-shell truck cap includes a lift assembly, a top panel, a front panel, a rear panel, and a pair of hinged side panels. The lift assembly is removably mountable in a bottom of a truck bed. The top panel has a front edge, a rear edge, and side edges. The top panel is attached to and movable up and down by the lift assembly. The front panel is attached to the top panel at the front edge, and the rear panel is attached to the top panel at the rear edge. The side panels each include an upper panel portion pivotably attached to the top panel at the side edges and a lower panel portion pivotably attached to the upper panel portion and pivotably connectable to an upper side portion of a truck bed frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to truck caps and more particularly pertains to a new collapsible hard-shell truck cap for providing users with the strength and security of a hard shell with the flexible design and height adjustment of a collapsible truck cap.

### (2) Description of Related Art Including Information Disclosed Under 37 CFR 1.97 and 1.98

The prior art relates to truck caps. The prior art, as best understood, does not disclose a collapsible hard-shell truck cap that includes a lift assembly and a pair of hinged side panels, each of which includes an upper panel portion and a lower panel portion pivotably attached to the upper panel portion and pivotably connectable to an upper side portion of a truck bed frame.

### BRIEF SUMMARY OF THE INVENTION

An embodiment of the disclosure meets the needs presented above in a collapsible hard-shell truck cap generally comprising a lift assembly, a top panel, a front panel, a rear panel, and a pair of hinged side panels. The lift assembly is removably mountable in a bottom of a truck bed. The top panel has a front edge, a rear edge, and side edges. The top panel is attached to and movable up and down by the lift assembly. The front panel is attached to the top panel at the front edge, and the rear panel is attached to the top panel at the rear edge. The side panels each include an upper panel portion pivotably attached to the top panel at the side edges and a lower panel portion pivotably attached to the upper panel portion and pivotably connectable to an upper side portion of a truck bed frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a collapsible hard-shell truck cap according to an embodiment of the disclosure.

FIG. 2 is a perspective view of an embodiment of the disclosure.

FIG. 3 is a side view of an embodiment of the disclosure.

FIG. 4 is a side cross-sectional view of an embodiment of the disclosure.

FIG. 5 is a side cross-sectional view of an embodiment of the disclosure.

FIG. 6 is a rear cross-sectional view of an embodiment of the disclosure.

FIG. 7 is a rear cross-sectional view of an embodiment of the disclosure.

FIG. 8 is a rear cross-sectional view of a portion of an embodiment of the disclosure.

### DETAILED DESCRIPTION OF THE INVENTION

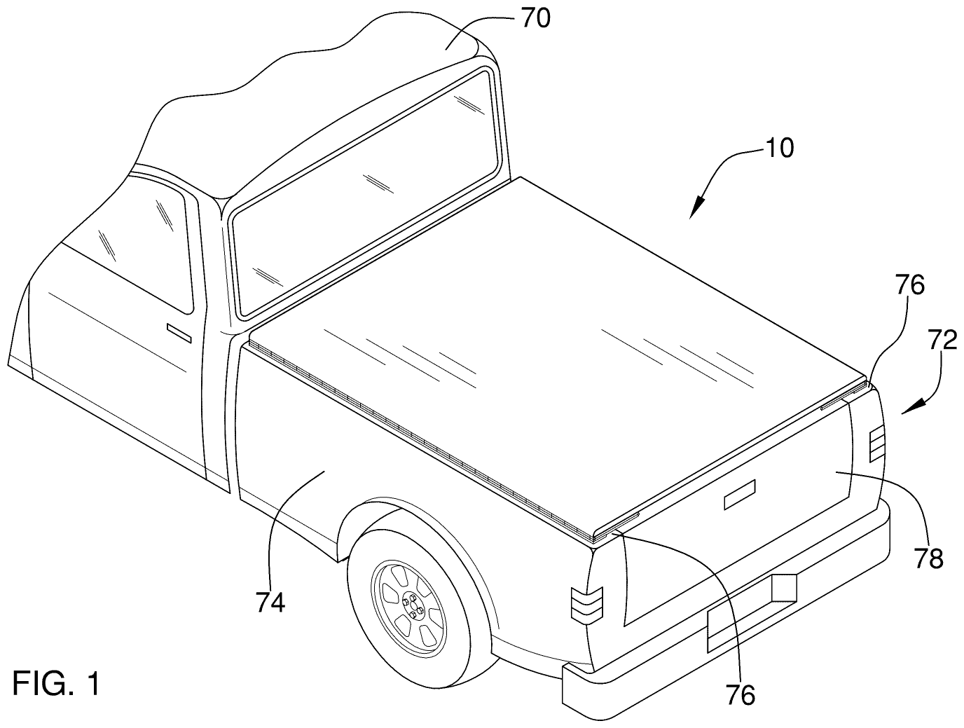

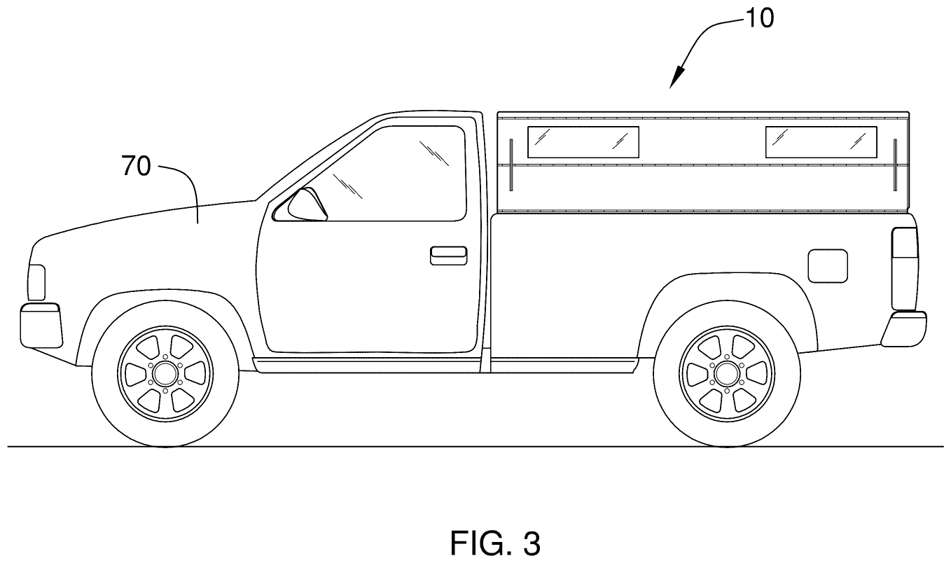

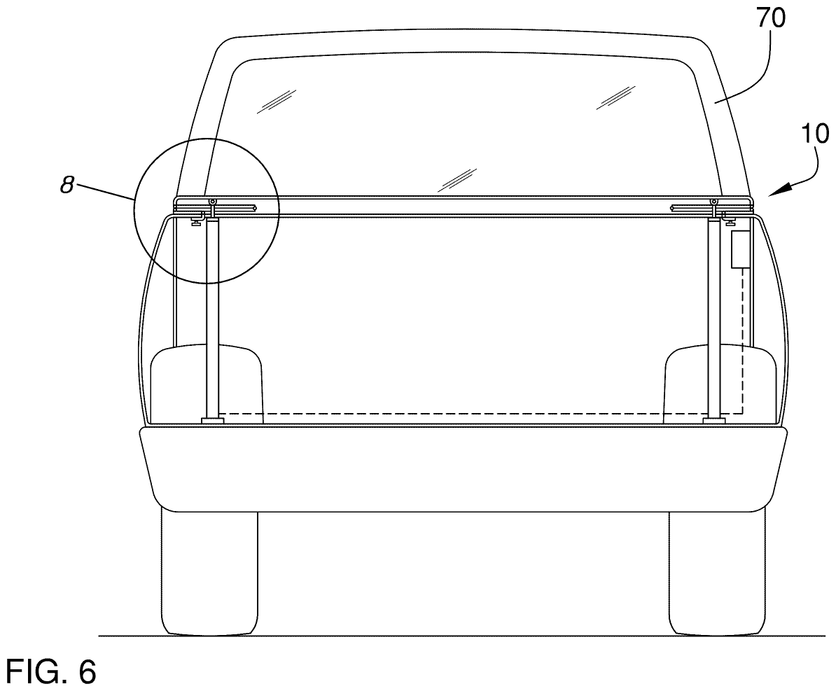

With reference now to the drawings, and in particular to FIGS. 1 through 8 thereof, a new collapsible hard-shell truck cap embodying the principles and concepts of an embodiment of the disclosure and generally designated by the reference numeral 10 will be described.

As best illustrated in FIGS. 1 through 8, the collapsible hard-shell truck cap 10 generally comprises a lift assembly 12, a top panel 14, a front panel 16, a rear panel 18, and a pair of hinged side panels 20. The lift assembly 12 is removably mountable in a bottom of a truck bed 72. The top panel 14 has a front edge 22, a rear edge 24, and side edges 26. The top panel 14 is attached to and movable up and down by the lift assembly 12. The front panel 16 is attached to the top panel 14 at the front edge 22, and the rear panel 18 is attached to the top panel 14 at the rear edge 24. The side panels 20 each include an upper panel portion 28 pivotably attached to the top panel 14 at the side edges 26 and a lower panel portion 30 pivotably attached to the upper panel portion 28 and pivotably connectable to an upper side portion 76 of a truck bed frame 74.

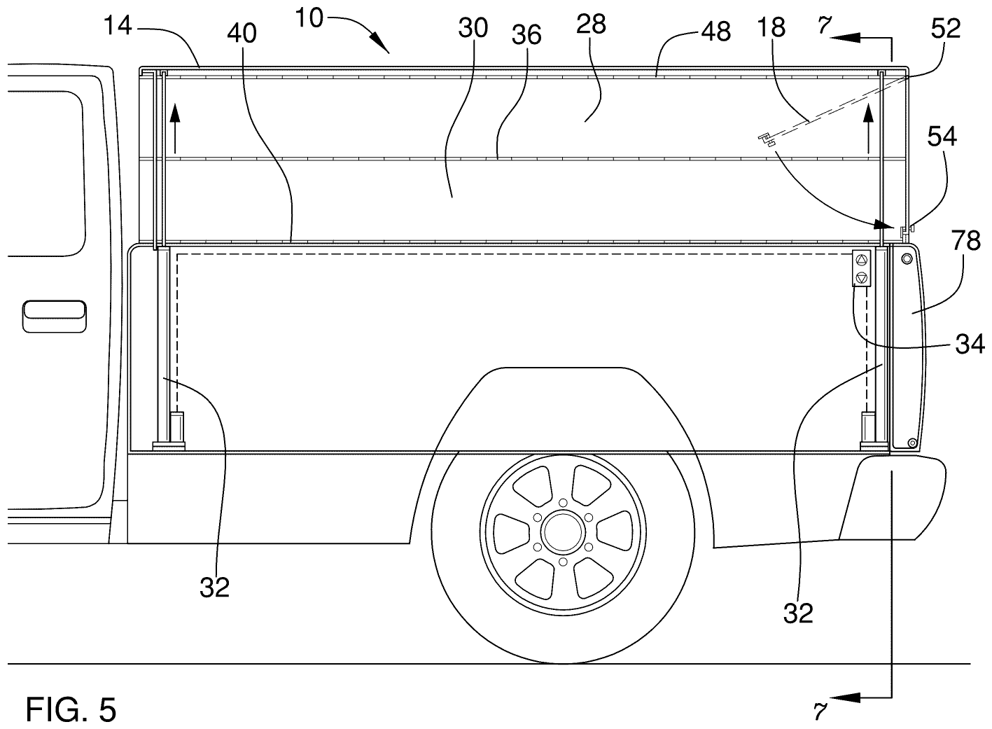

FIGS. 1 through 8 shows one possible exemplary embodiment of the collapsible hard-shell truck cap 10 and should not be considered as limiting the disclosure or the claims, as variations are within the scope of the disclosure. As shown in FIG. 5, the lift assembly 12 includes a plurality of linear pistons 32 and a control unit 34 operatively connected thereto to extend and retract the linear pistons 32. The linear pistons 32 could be replaced by stepper motors or screw drives or any similar lifting device. The control unit 34 could be a push button assembly as shown in FIG. 5, though an electronic control unit could be used.

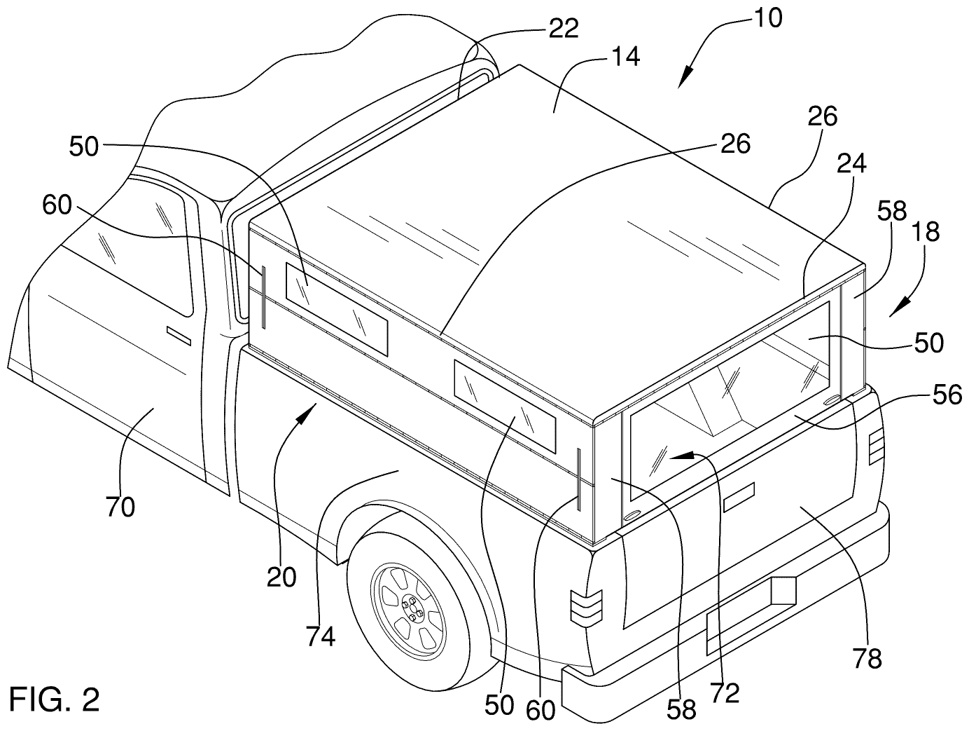

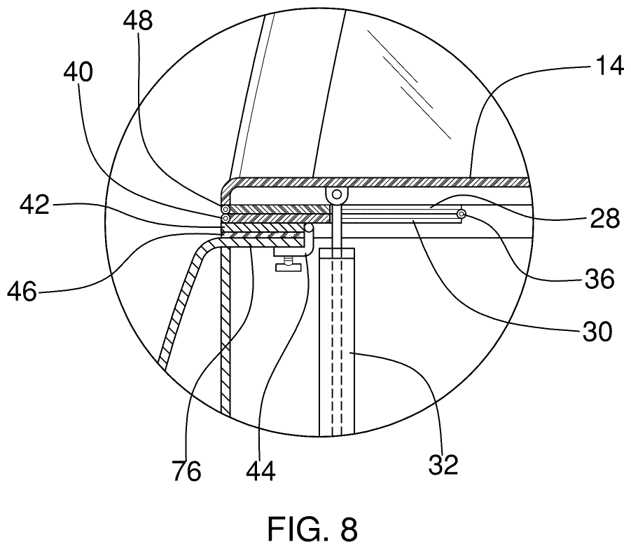

As best seen in the close-up view in FIG. 8, the upper and lower panel portions 28, 30 are connected by a center hinge 36 designed to permit the upper and lower panel portions 28, 30 to collapse inwardly in a stacked manner under the top panel 14. Each of the side panels 20 includes a clamping structure 38 connected to the lower panel portion 30 by a lower hinge 40 and designed to detachably clamp onto the upper side portion 76 of the truck bed frame 74. In the exemplary embodiment shown in FIG. 8, the clamping structure 38 could include a top plate 42, an adjustable clamping arm 44, and a sealing layer 46 attached to the top plate 42 that rests against a top surface of the upper side portion 76 of the truck bed frame 74. The clamping structure 38 is removably connected, but in another possible embodiment the clamping structure 38 could be permanently attached to or integrally formed with the truck bed frame 74. The upper panel portion 28 is connected to the top panel 14 by an upper hinge 48. As shown in FIG. 2, the upper panel portion 28 includes two windows 50, though in another possible embodiment either or both of the upper and lower panel portions 28, 30 could include one or more windows 50.

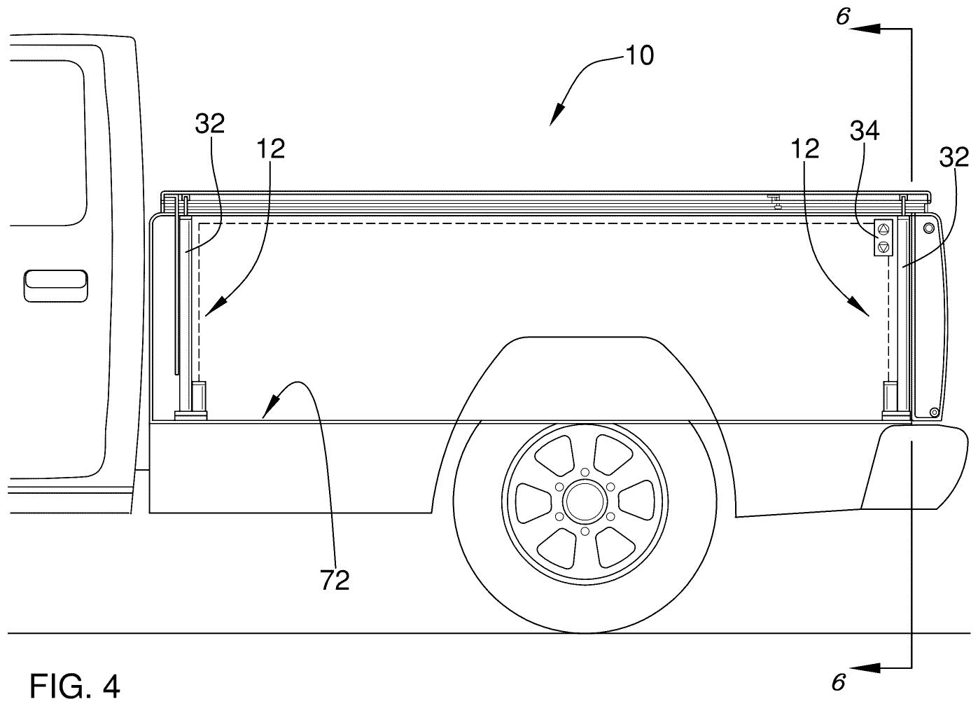

As shown in FIG. 5, the front panel 16 is fixedly attached to the top panel 14 and designed to be moved into a truck bed 72 when the top panel 14 is moved down, as shown in FIG. 4. In another possible embodiment, the front panel 16 could be pivotably attached to the top panel 14 and foldable under the top panel 14. In one possible embodiment, the front panel 16 could include a window. The rear panel 18 can also include a window 50.

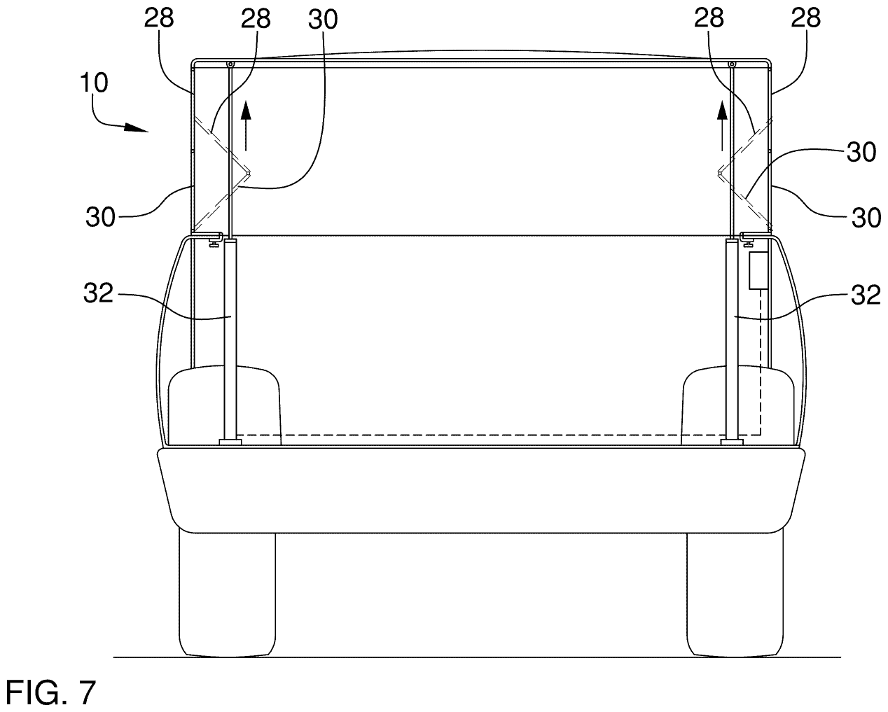

As shown in FIG. 5, the rear panel 18 is pivotably connected to the rear edge 24 by a rear hinge 52 designed to permit the rear panel 18 to fold against the top panel 14 in a stacked manner. In the exemplary embodiment in FIG. 5, the rear panel 18 is folded under the top panel 14. The rear panel 18 could include a door latch 54 that is lockable to a rear door 78 of the truck bed 72. As shown in FIG. 2, the rear panel 18 can include a central portion 56 and two side portions 58 that are foldable to provide clearance to allow the rear panel 18 to be moved in between two of the linear pistons 32 when they are extended, as shown in FIG. 7. However, in another possible embodiment, the linear pistons 32 could be positioned a distance away from the rear edge 24 to provide room for the rear panel 18 to fold inwardly without the need for the two side portions 58.

As shown in FIG. 2, in one possible embodiment the side panels 20 could include slots 60 that are aligned with the linear pistons 32. When the side panels 20 are collapsed inwardly, the slots 60 allow the side panels 20 to receive the linear pistons 32 therein and not be stopped or blocked by the inward moving side panels 20. Again, this is one possible embodiment and the slots 60 could be omitted for lifting assemblies of a different configuration.

Each of the top panel 14, the side panels 20, the front panel 16, and the rear panel 18 is made of a hard material. The hard material could be a hard plastic, metal, or tempered glass. Some examples of usable materials are anodized aluminum, fiberglass, acrylics, polycarbonate, and silicone.

In operation, when the linear pistons 32 are extended, as shown in FIG. 5, the side panels 20 are flattened and the top panel 14 is raised such that the collapsible hard-shell truck cap 10 is fully expanded, as shown in FIG. 2. When the linear pistons 32 are retracted, as shown in FIG. 4, the side panels 20 are collapsed and stacked and the top panel 14 is lowered such that the collapsible hard-shell truck cap 10 is fully collapsed, as shown in FIG. 1.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collapsible hard-shell truck cap comprising:
a lift assembly removably mountable in a bottom of a truck bed;
a top panel having a front edge, a rear edge, and side edges, wherein said top panel is attached to and movable up and down by said lift assembly;
a front panel attached to said top panel at said front edge;
a rear panel attached to said top panel at said rear edge; and
a pair of hinged side panels, each comprising an upper panel portion pivotably attached to said top panel at said side edges and a lower panel portion pivotably attached to said upper panel portion and pivotably connectable to an upper side portion of a truck bed frame.

2. The collapsible hard-shell truck cap of claim 1, wherein said upper and lower panel portions are connected by a center hinge configured to permit said upper and lower panel portions to collapse inwardly in a stacked manner under said top panel.

3. The collapsible hard-shell truck cap of claim 1, wherein each of said side panels comprises a clamping structure connected to said lower panel portion by a lower hinge and configured to detachably clamp onto an upper side portion of a truck bed frame.

4. The collapsible hard-shell truck cap of claim 1, wherein said upper panel portion is connected to said top panel by an upper hinge.

5. The collapsible hard-shell truck cap of claim 1, wherein said upper panel portion comprises a window.

6. The collapsible hard-shell truck cap of claim 1, wherein said lift assembly comprises a plurality of linear pistons and a control unit operatively connected thereto to extend and retract said linear pistons.

7. The collapsible hard-shell truck cap of claim 1, wherein said front panel is fixedly attached to said top panel and configured to be moved into a truck bed when said top panel is moved down.

8. The collapsible hard-shell truck cap of claim 1, wherein said rear panel is pivotably connected to said rear edge by a rear hinge configured to permit said rear panel to fold against said top panel in a stacked manner.

9. The collapsible hard-shell truck cap of claim 1, wherein said rear panel comprises a window.

10. The collapsible hard-shell truck cap of claim 1, wherein each of said top panel, said side panels, said front panel, and said rear panel is made of a hard material comprising hard plastic, metal, or tempered glass.

11. A collapsible hard-shell truck cap comprising:
a lift assembly removably mountable in a bottom of a truck bed, wherein:
said lift assembly comprises a plurality of linear pistons and a control unit operatively connected thereto to extend and retract said linear pistons;
a top panel having a front edge, a rear edge, and side edges, wherein said top panel is attached to and movable up and down by said lift assembly;
a front panel attached to said top panel at said front edge, wherein:
said front panel is fixedly attached to said top panel and configured to be moved into a truck bed when said top panel is moved down;
a rear panel attached to said top panel at said rear edge, wherein:
said rear panel is pivotably connected to said rear edge by a rear hinge configured to permit said rear panel to fold against said top panel in a stacked manner,
said rear panel comprises a window; and
a pair of hinged side panels, each comprising an upper panel portion pivotably attached to said top panel at said side edges and a lower panel portion pivotably attached to said upper panel portion and pivotably connectable to an upper side portion of a truck bed frame, wherein:
said upper and lower panel portions are connected by a center hinge configured to permit said upper and lower panel portions to collapse inwardly in a stacked manner under said top panel,
each of said side panels comprises a clamping structure connected to said lower panel portion by a lower hinge and configured to detachably clamp onto an upper side portion of a truck bed frame,
said upper panel portion is connected to said top panel by an upper hinge,
said upper panel portion comprises a window.

12. The collapsible hard-shell truck cap of claim 12, wherein each of said top panel, said side panels, said front panel, and said rear panel is made of a hard material comprising hard plastic, metal, or tempered glass.
